(19) United States
(12) Patent Application Publication
(10) Pub. No.: US 2016/0062621 A1
(43) Pub. Date: Mar. 3, 2016

(54) USER INTERFACE FOR FUNNEL ANALYSIS

(71) Applicants: Erin Delacroix, Mountain View, CA (US); Christina Lynn Lopus, San Francisco, CA (US); James Lee Baker, San Jose, CA (US); Benjamin Arai, San Jose, CA (US); Kaushik Rangadurai, Mountain View, CA (US); Deepak Neralla, Mountain View, CA (US); Ishita Shah, Cupertino, CA (US); Sanketh Suresh Katta, San Francisco, CA (US)

(72) Inventors: Erin Delacroix, Mountain View, CA (US); Christina Lynn Lopus, San Francisco, CA (US); James Lee Baker, San Jose, CA (US); Benjamin Arai, San Jose, CA (US); Kaushik Rangadurai, Mountain View, CA (US); Deepak Neralla, Mountain View, CA (US); Ishita Shah, Cupertino, CA (US); Sanketh Suresh Katta, San Francisco, CA (US)

(21) Appl. No.: 14/473,372

(22) Filed: Aug. 29, 2014

(51) Int. Cl. G06F 3/0484; G06Q 10/10; G06Q 30/06

(52) U.S. Cl. CPC G06F 3/04847; G06Q 30/0641; G06Q 10/10; G06F 3/04842

(57) ABSTRACT

Techniques for providing information describing how users are funneling through various products and features of a website are described. According to various embodiments, a user specification of a first set of one or more entities is received. A user interface element is then displayed, the user interface element indicating an amount of total online user sessions that include user interactions with at least one of the entities in the first set during a specific time interval. Thereafter, a user specification of a second set of one or more entities is received. A second user interface element is then displayed, the second user interface element indicating a subset of the total online user sessions that include user interactions with at least one of the entities in the second set subsequent to the user interactions with at least one of the entities in the first set.

### TECHNICAL FIELD

The present application relates generally to data processing systems and, in one specific example, to techniques for providing information describing how users are funneling through various products and features of a website.

### BACKGROUND

Online social network services such as LinkedIn® are becoming increasingly popular, with many such websites boasting millions of active members. Each member of the online social network service is able to upload an editable member profile page to the online social network service. The member profile page may include various information about the member, such as the member's biographical information, photographs of the member, and information describing the member's employment history, education history, skills, experience, activities, and the like. Such member profile pages of the networking website are viewable by, for example, other members of the online social network service.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the present disclosure;

FIG. 2 is a block diagram of an example system, according to various embodiments;

FIG. 3 illustrates an example portion of a user interface, according to various embodiments;

FIG. 4 illustrates an example portion of a user interface, according to various embodiments;

FIG. 5 illustrates an example portion of a user interface, according to various embodiments;

FIG. 6 illustrates an example portion of a user interface, according to various embodiments;

FIG. 7 illustrates an example portion of a user interface, according to various embodiments;

FIG. 8 illustrates an example portion of a user interface, according to various embodiments;

FIG. 9 illustrates an example portion of a user interface, according to various embodiments;

FIG. 10 illustrates an example portion of a user interface, according to various embodiments;

FIG. 11 illustrates examples of various data structures and/or data structure entities, according to various embodiments;

FIG. 12 is a flowchart illustrating an example method, according to various embodiments;

FIG. 13 is a flowchart illustrating an example method, according to various embodiments;

FIG. 14 is a flowchart illustrating an example method, according to various embodiments;

FIG. 15 is a flowchart illustrating an example method, according to various embodiments;

FIG. 16 illustrates an example mobile device, according to various embodiments; and

FIG. 17 is a diagrammatic representation of a machine in the example form of a computer system within which a set of instructions, for causing the machine to perform any one or more of the methodologies discussed herein, may be executed.

### DETAILED DESCRIPTION

Example methods and systems for providing information describing how users are funneling through various products and features of a website are described. In the following description, for purposes of explanation, numerous specific details are set forth in order to provide a thorough understanding of example embodiments. It will be evident, however, to one skilled in the art that the embodiments of the present disclosure may be practiced without these specific details.

Various embodiments herein describe improved user funnel analysis and user site flow analysis techniques, thereby enabling greater understanding of how users step through a site and engage with different features and products of a site. For example, a funnel analysis system may display a user interface allowing an operator to setup different “levels” (also referred to herein as steps, stages, or phases) that define sequential user interaction events with entities associated with a particular website (e.g., a website of an online social networking service) during various online user sessions. For example, the first level may define a first interaction event with a first entity associated with a website (e.g., the start of an online session where a user first visits a homepage of the website), a second level may define a second interaction event with a second entity associated with the website that occurs immediately after the first interaction event with the first entity (e.g., when the user moves from the homepage to a subpage of the website), a third level may define a third interaction event with a third entity associated with the website that occurs immediately after the second interaction event with the second entity (e.g., when the user performs an action from the subpage, such as sending a member-to-member connection invitation), and so on. The entities described herein may include a page key entity type (corresponding to a user interaction with a particular webpage), a page key group entity type (corresponding to a user interaction with a webpage in a particular group of webpages), and a user action entity type (corresponding to a user performing a particular user action or interacting with a command button to perform that action).

After the levels are configured appropriately, the funnel analysis system may display information indicating a number of online user sessions-during a specific time period (e.g., the last 7 days)—that begin with user interaction events with the entities defined at the first level. The funnel analysis system may also display information indicating how many of those online user sessions continued with interactions with the entities defined at the second level immediately after the interactions with the entities defined at the first level, as well information indicating how many of those online user sessions continued with interactions with the entities defined at the third level immediately after the interactions with the entities defined at the second level, and so on. Thus, the funnel analysis system enables operators to see how users funnel through various entities associated with a website.

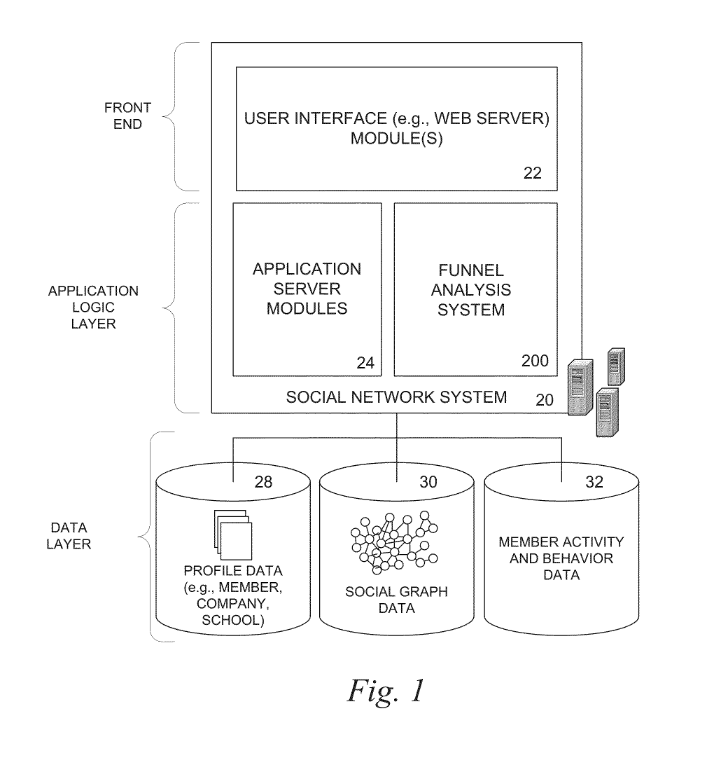

FIG. 1 is a block diagram illustrating various components or functional modules of a social network service such as the social network system 20, consistent with some embodiments. As shown in FIG. 1, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 24. Similarly, a variety of other applications or services that are made available to members of the social network service will be embodied in their own application server modules 24.

As shown in FIG. 1, the data layer includes several databases, such as a database 28 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 1 by the database with reference number 32.

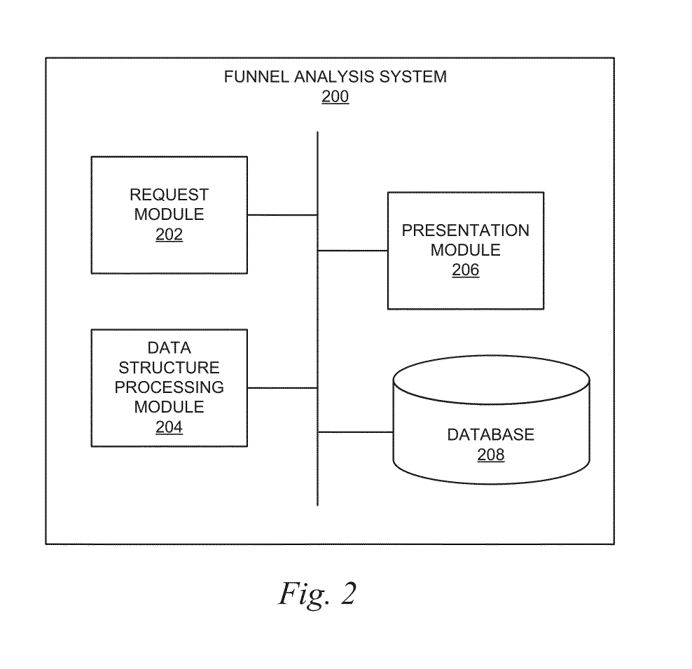

With some embodiments, the social network system 20 includes what is generally referred to herein as a funnel analysis system 200. The funnel analysis system 200 is described in more detail below in conjunction with FIG. 2.

Although not shown, with some embodiments, the social network system 20 provides an application programming interface (API) module via which third-party applications can access various services and data provided by the social network service. For example, using an API, a third-party application may provide a user interface and logic that enables an authorized representative of an organization to publish messages from a third-party application to a content hosting platform of the social network service that facilitates presentation of activity or content streams maintained and presented by the social network service. Such third-party applications may be browser-based applications, or may be operating system-specific. In particular, some third-party applications may reside and execute on one or more mobile devices (e.g., phone, or tablet computing devices) having a mobile operating system.

Turning now to FIG. 2, a funnel analysis system 200 includes a request module 202, a data structure processing module 204, a presentation module 206, and a database 208. The modules of the funnel analysis system 200 may be implemented on or executed by a single device such as a funnel analysis device, or on separate devices interconnected via a network. The aforementioned funnel analysis device may be, for example, one or more client machines or application servers. The operation of each of the aforementioned modules of the funnel analysis system 200 will now be described in greater detail in conjunction with the figures.

As describe above, the funnel analysis system 200 may display a user interface allowing an operator to setup different “levels” (also referred to herein as steps, stages, or phases) that correspond to a sequential user interaction events with entities associated with a particular website during online user sessions.

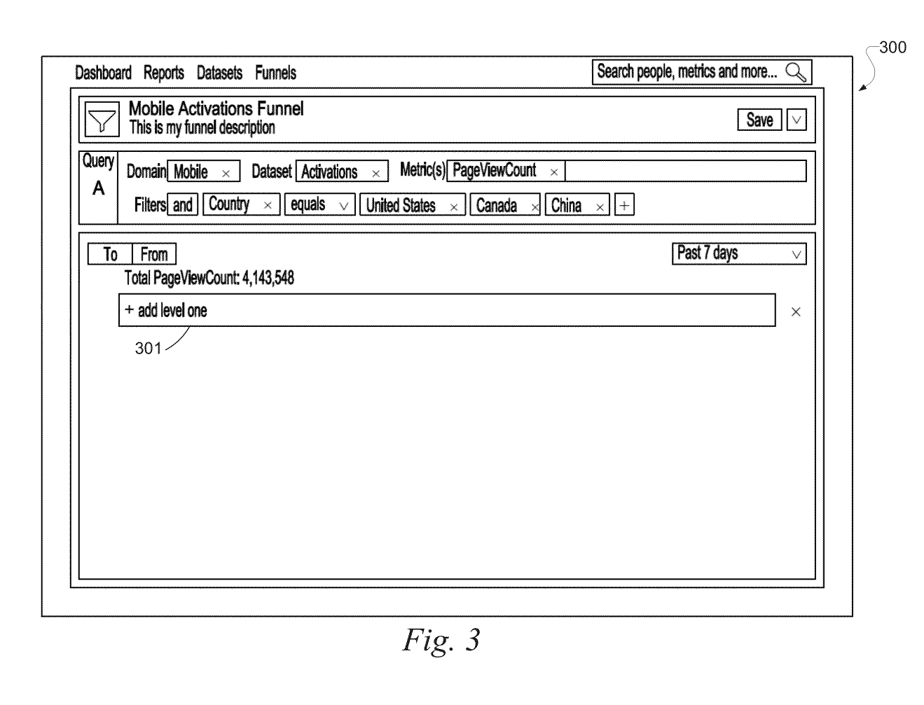

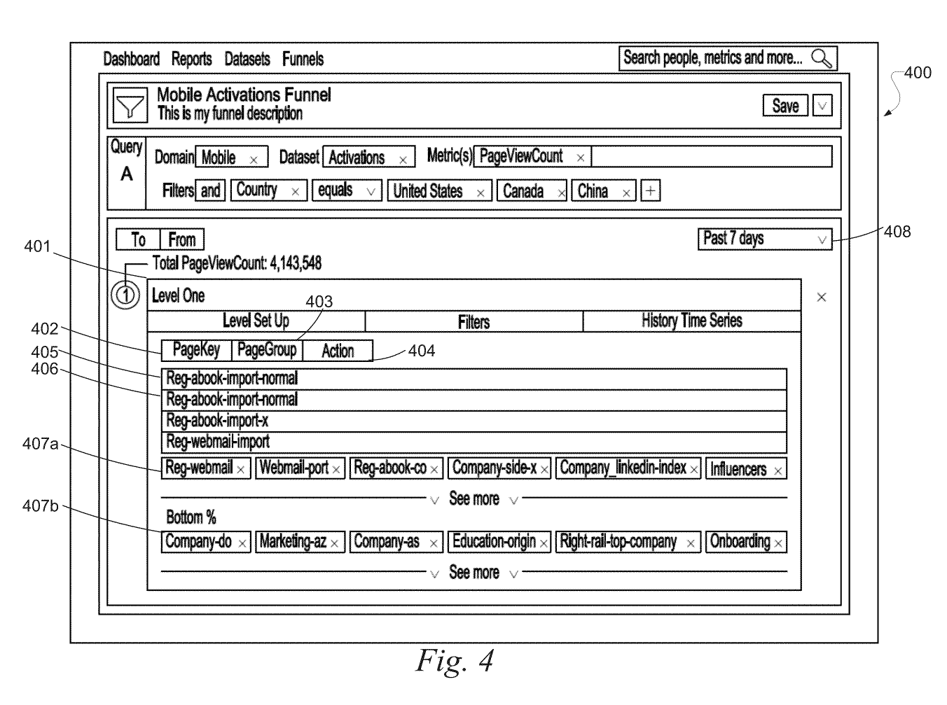

For example, FIG. 3 illustrates an example user interface 300 displayed by the funnel analysis system 200 that enables an operator of the funnel analysis system 200 to generate a report on user funnel and site flow activity by configuring one or more levels. In the user interface 300, no levels have yet been configured, and the operator may select the button 301 entitled “+ add level one” to add the first level, “Level One”. The funnel analysis system 200 may then display the user interface 400 in FIG. 4 to configure Level One and to associate various entities (e.g., page keys, page key groups, and/or user actions) with that level. For example, a “Level Set Up” user interface window 401 is displayed that includes a page key entity type button/selector 402, a page key group (a.k.a. page group) entity type button/selector 403, and a user action entity type button/selector 404. By selecting the appropriate selector, the user can select from and/or associate the corresponding types of entities with Level One. For example, in FIG. 4, the operator has selected the page key entity type button/selector 402, and they may enter the appropriate entity in the entity specification bar 405. In some embodiments, by starting to type a character or word such as “Reg-”, the funnel analysis system 200 may display a type ahead in the entity specification bar 405 and/or a drop down menu 406 displaying suggested page key type entities that the operator may wish to select from. Thus, any entities listed in the type ahead in the entity specification bar 405 and/or the drop down menu 406 are filtered to only include those entities of the type 402-404 selected by the user (e.g., page key entities as selected by selector 402 in FIG. 4). Moreover, the funnel analysis system 200 may display suggested entities 407a and 407b associated with the selected entity type 402-404 (e.g., notwithstanding any characters the operator may have entered into the entity specification bar 405). The operator may also utilize the pull down menu 408 to select an appropriate time period (e.g., a time and/or date range, “the last 7 days”, etc.).

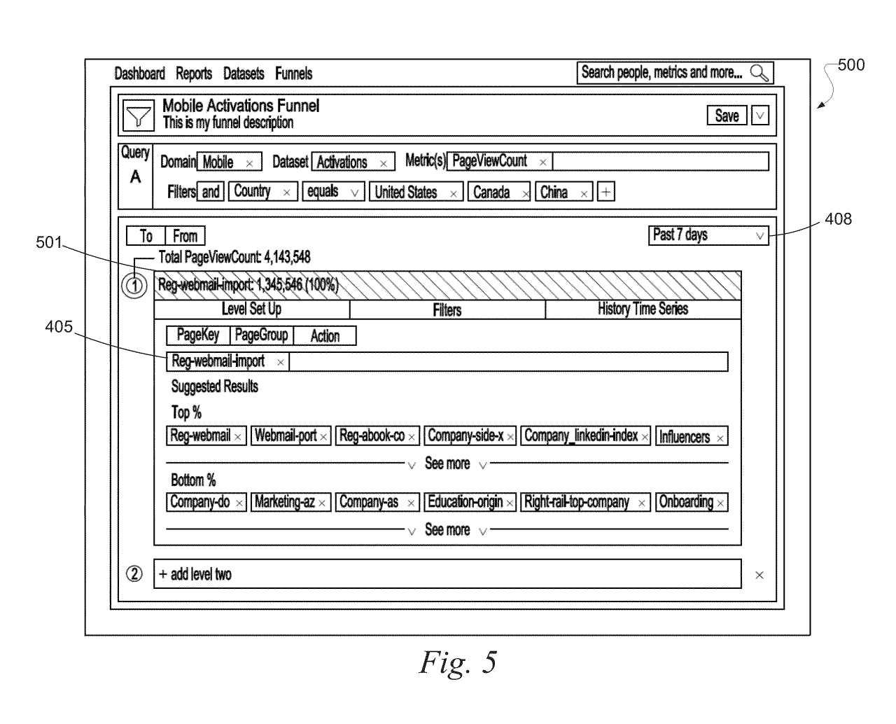

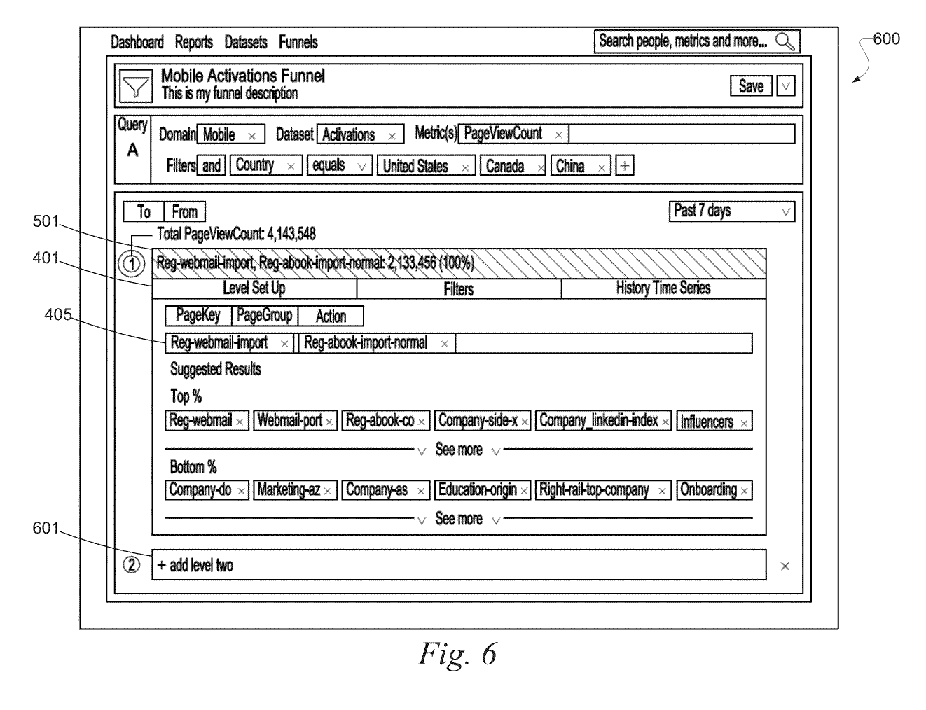

After the operator selects an entity such as “Reg-webmail-import” in FIG. 4, then, as illustrated in user interface 500 in FIG. 5, that entity is populated into the entity specification bar 405 and becomes associated with Level One. The Level One count bar 501 then displays a total number of online sessions (e.g., “1,345,546”), during the specified time period 408, that began with the user interactions with the specified entity (e.g., visits to the “Reg-webmail-import” webpage). The Level One count bar 501 will also display a percentage of relevant user online sessions (e.g., from a higher level) satisfying this criteria (which will be 100% since this is the first level). The Level One count bar 501 is also colored as a bar graph to represent the aforementioned 100% metric. As illustrated in the user interface 600 in FIG. 6, the operator may add additional entities to Level One, such as the page key entity “Reg-abook-import-normal”. Consequently, the total count in the Level One count bar 501 has been increased to 2,133,456 to reflect the total number of online sessions, during the specified time period 408, that began with the user interactions with one of the entities specified in entity specification bar 405 and associated with Level One (e.g., visits to either the “Reg-webmail-import” webpage or “Reg-abook-import-normal” webpage).

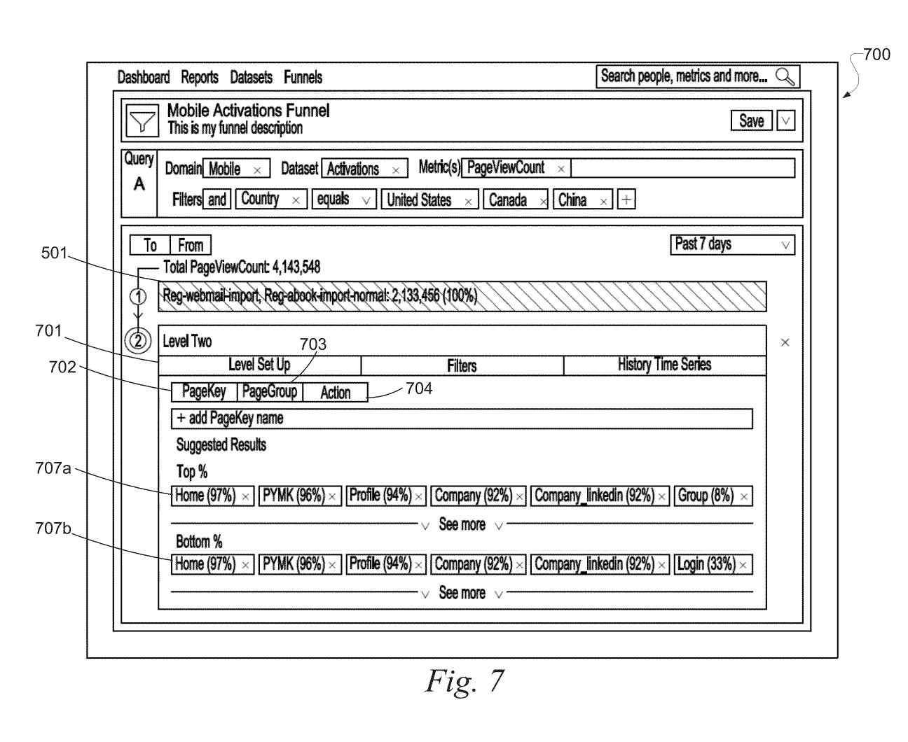

Thereafter, if the operator selects the “+ add level two” button 601, the operator may perform a similar operation described above for associating entities with Level Two. For example, as seen in the user interface 700 in FIG. 7, the user interface window 401 is hidden, the user interface window 701 appears, the operator has selected the page key entity type selector 702, and the suggested entities 707a and 707b have been updated to reflect suggested entities of the selected entity type 702.

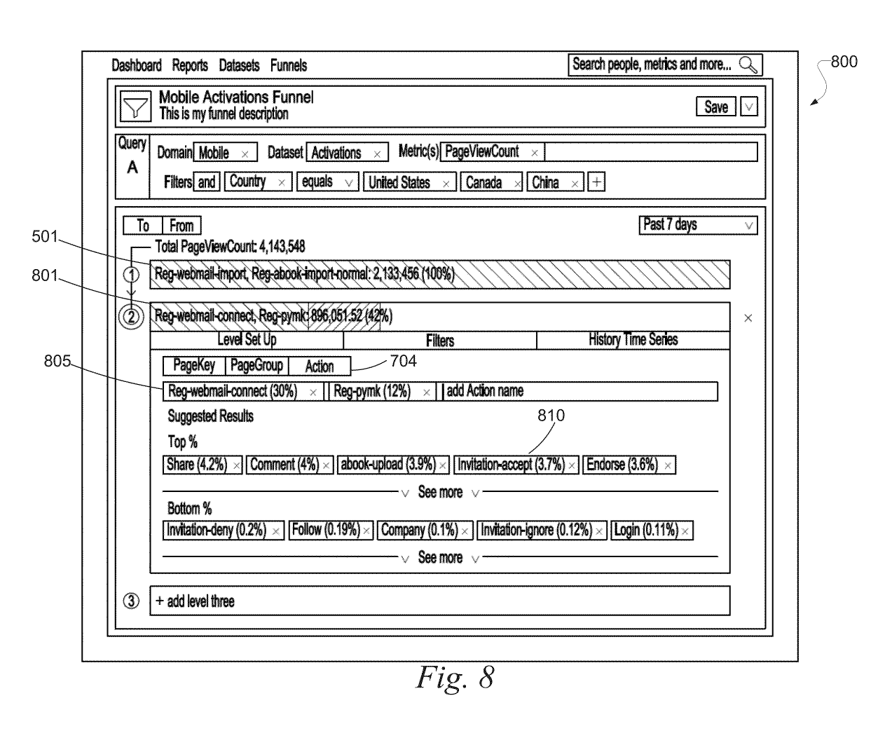

If the user associates a page key type entity (e.g., “Reg-webmail-connect” webpage) and a page key group entity type (e.g., “Reg-pymk” group of webpages) with Level Two then, as seen in the user interface 800 in FIG. 8, these entities appear in the entity selection bar 805. Moreover, the Level Two count bar 801 is modified to indicate a size “896,051.52” of a subset of the total number of online sessions (as identified in Level One count bar 501) that include an interaction with one of the entities associated with Level Two (e.g., one of the entities specified in entity specification bar 805) subsequent to the interaction with one of the entities associated with Level One. In the example seen in FIG. 8, 2,133,456 sessions began on either the “Reg-webmail-import” webpage or “Reg-abook-import-normal” webpages, and then 896,051.52 (or 42%) of those total sessions continued with an interaction with either the “Reg-webmail-connect” webpage or at least one of the webpages in the “Reg-pymk” group of webpages. The Level Two count bar 801 also displays the percentage (42%) of the relevant user online sessions (e.g., 2,133,456 from Level One) satisfying the Level Two definitions. The Level Two count bar 801 is also colored as a bar graph to represent the 42% metric relationship with the Level One count bar. As illustrated in FIG. 8, when the user selects entities in the entity specification bar 805, percentages are displayed for each entity (e.g., 30% and 12%) indicating the percentage of the total online user online sessions (e.g., 2,133,456 from Level One) that include user interactions with each entity (e.g., “Reg-webmail-connect” webpage and “Reg-pymk” group of webpages, respectively). The Level Two count bar 801 also includes different colors/shading to indicate these percentages, that is, the respective makeup of the different entity types associated with Level Two (e.g., a first color for the page key entities, a second color for the page key group entities, a third color for the user action entity types, and so on).

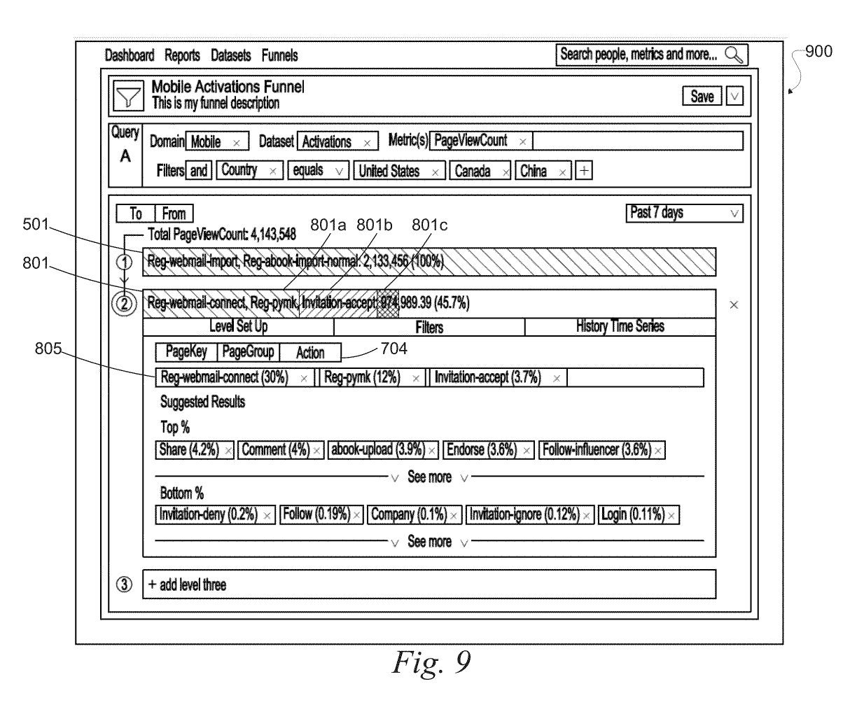

If the operator selects the user action entity type selector 704 in FIG. 8, then, as illustrated in the user interface 900 in FIG. 9, the user may also associate an action (e.g., “invitation-accept”, or accepting a member-to-member invitation) with Level Two, and this entity appears in the entity selection bar 805. Moreover, the Level Two count bar 801 is modified to indicate a size “974,989.39” of a subset of the total number of online sessions (as identified in Level One count bar 501) that include an interaction with one of the entities associated with Level Two (e.g., one of the entities specified in entity specification bar 805) subsequent to the interaction with one of the entities associated with Level One. In the example seen in FIG. 9, 2,133,456 sessions began on either the “Reg-webmail-import” webpage or “Reg-abook-import-normal” webpages, and then 974,989.39 (or 45.7%) of the total sessions continued with an interaction with either the “Reg-webmail-connect” webpage, or at least one of the webpages in the “Reg-pymk” group of webpages, or with the user accepting a member-to-member invitation (e.g., by interacting with a “invite-accept” button). The Level Two count bar 801 also displays the percentage (45.7%) of the relevant user online sessions (e.g., 2,133,456 from Level One) satisfying the Level Two definitions. The Level Two count bar 801 is also colored as a bar graph to represent the 45.7% metric relationship with the Level One count bar. As illustrated in FIG. 9, when the user selects entities in the entity specification bar 805, percentages are displayed for each entity (e.g., 30%, 12%, and 3.7%) indicating the percentage of the total online user online sessions (e.g., 2,133,456 from Level One) that include user interactions with each entity (e.g., “Reg-webmail-connect” webpage, “Reg-pymk” group of webpages, and accepting a member-to-member invitation, respectively). The Level Two count bar 801 also includes different colors/shading 801a-c to indicate these percentages, that is, the respective makeup of the different entity types associated with Level Two (e.g., a first color for the page key entities, a second color for the page key group entities, a third color for the user action entity types, and so on).

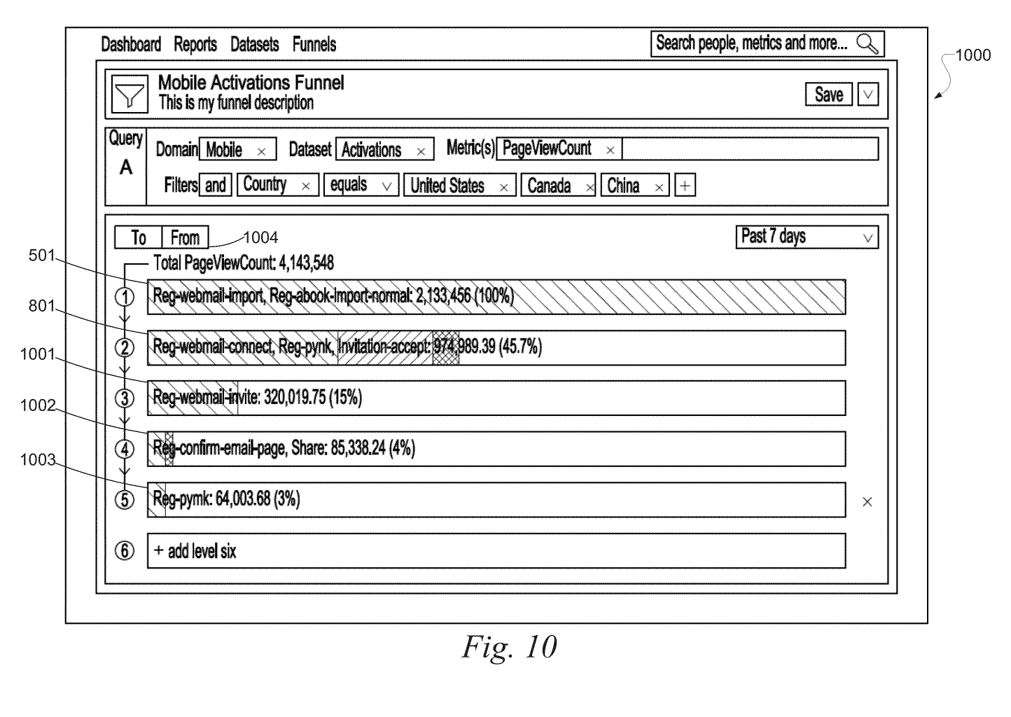

In this manner, the operator may add a plurality of levels, each associated with various entities, in order to track site flow. For example, as illustrated in the user interface 1000 in FIG. 10, the operator has associated Level Three with the “Reg-webmail-invite” webpage, Level Four with the “Reg-confirm-email-page” webpage and the “Share” user action, and Level Five with the “Reg-Pymk” group of webpages. Each of the level count bars 501, 801, 1001, 1002, and 1003, indicate a size of a subset of the total number of online sessions (as identified in Level One count bar 501) that include an interaction with one of the entities associated with that level subsequent to the interactions with one of the entities associated with each of the previous levels. In the example seen in FIG. 10, 2,133,456 sessions began on either the “Reg-webmail-import” webpage or “Reg-abook-import-normal” webpages, and then 974,989.39 (or 45.7%) of the total sessions continued with an interaction with either the “Reg-webmail-connect” webpage, or at least one of the webpages in the “Reg-pymk” group of webpages, or with the user accepting a member-to-member invitation (e.g., by interacting with a “invite-accept” button), and then 320,019.75 (or 15%) of the total sessions continued further with an interaction with the “Reg-webmail-invite” webpage, and then 85,338.24 (or 4%) of the total sessions continued further with an interaction with either the “Reg-confirm-email-page” webpage or the “Share” user action, and then 64,003.68 (or 3%) of the total sessions continued further with an interaction with the “Reg-Pymk” group of webpages. Each of the level count bars 501, 801, 1001, 1002, and 1003, also displays the percentage of the relevant user online sessions satisfying that level's definitions. Each of the level count bars 501, 801, 1001, 1002, and 1003 is also colored as a bar graph to represent the aforementioned percentages. Each of the level count bars 501, 801, 1001, 1002, and 1003 also includes different colors/shading to indicate the respective makeup of the different entity types associated with each level (e.g., a first color for the page key entities, a second color for the page key group entities, a third color for the user action entity types, and so on).

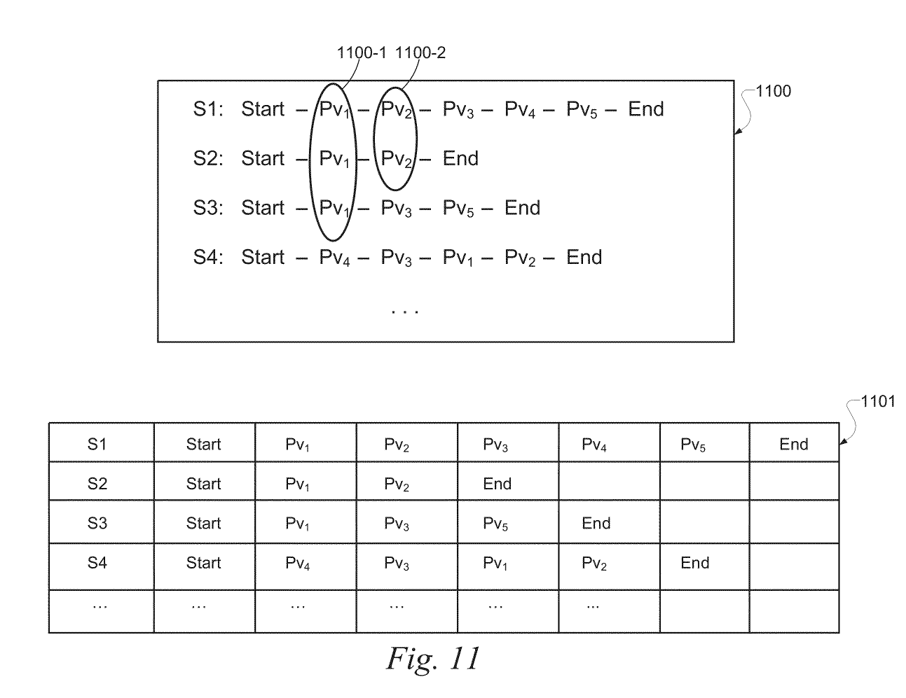

Various backend techniques may be utilized to generate the user interfaces described above. For example, the funnel analysis system 200 may efficiently store a plurality of data chains (also referred to as data structures or data structure entities herein), where each data chain represents an individual user session. For example, FIG. 11 illustrates example data chains 1100 for sessions S1-S4. For example, for session S1, the data chain includes a start element indicating when the session started, a page key view element “Pv1” element indicating a user interaction with page 1, a page key view element “Pv2” element indicating a user interaction with page 2, etc., as well as an End element indicating when the session ended. Each of the page key view elements may be associated with various information, such as information identifying the underlying page, the time or time range of the viewing/access of that page, and so on.

The page key view elements may be retrieved from user log data maintained by the website, whereas the funnel analysis system 200 may generate and insert the Start and End elements. For example, the funnel analysis system 200 may generate the Start element based on the first time when the user accesses/logs into the site and/or begins viewing page 1. Moreover, the funnel analysis system 200 may generate the End element based on various criteria (e.g., based on when the user logs off, based on a certain amount of time passing after the start of viewing page 5, or if there is a browser change detected, etc.).

The funnel analysis system 200 may store the chains 1100 in the form of data records or data rows in a data table 1101, database, or other data structure in memory (e.g., database 208 illustrated in FIG. 2). While the data chains 1100 include only page key view elements for simplicity, it is understood that they may similarly include page key group view elements or user actions elements as appropriate. In some embodiments, the data structure processing module 204 may store page key group definition data (e.g., in database 208) identifying the page keys associated with each page key group, and may utilize this information to determine if any page view event in a data chain corresponds to a particular page key group view event.

According to various example embodiments, once an operator associates various entities with Level One, the funnel analysis system 200 will retrieve only the subset of the data chains 1100 that have those entities at the first position after the Start elements. For example, if the operator associates page 1 with Level One, then the funnel analysis system 200 will only retrieve that set of chains 1100-1 that begin with Pv1, as illustrated in FIG. 11. Thereafter, if the operator associates page 2 with Level Two, then the funnel analysis system 200 will only analyze the retrieved set of chains 1100-1 that begin with Pv1 (and not the entire set of chains 1100) and retrieve, from only that set of chains 1100-1, the subset of chains 1100-2 with Pv2 in the second position, as illustrated in FIG. 11. Thus, since each successive retrieval may result in smaller and smaller subsets of data chains to be analyzed, the funnel analysis system 200 need not analyze the entire set of chains 1100 at each step. Accordingly, the computation time, complexity, and power required at each step may become successfully smaller.

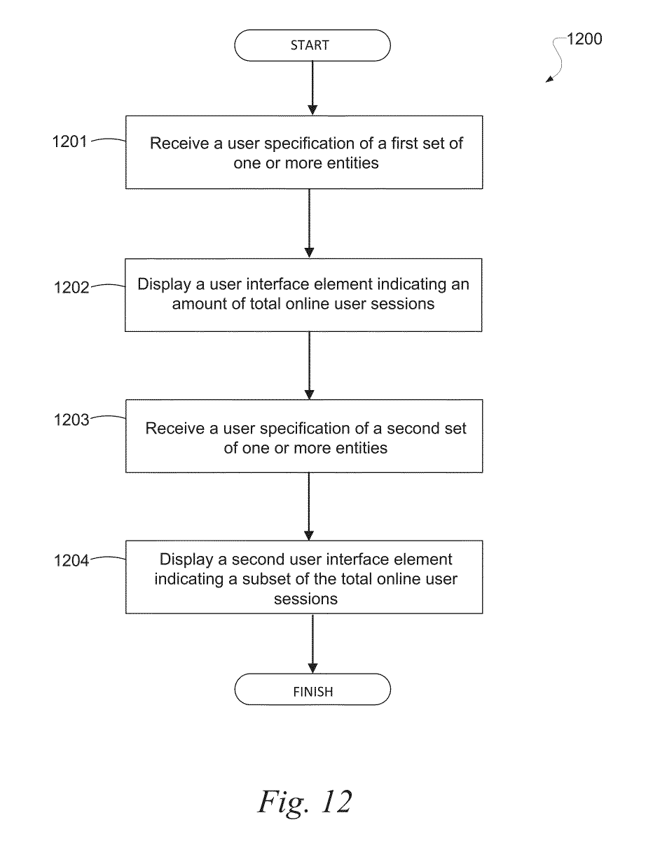

FIG. 12 is a flowchart illustrating an example method 1200, according to various example embodiments. The method 1200 may be performed at least in part by, for example, the funnel analysis system 200 illustrated in FIG. 2 (or an apparatus having similar modules, such as one or more client machines or application servers). In operation 1201 in FIG. 12, the request module 202 receives a user specification of a first set of one or more entities (e.g., see 405 in FIG. 6) and a specific time interval (e.g., see 408 in FIG. 4). Each of the entities in the first set may be associated with at least one of a page key entity type corresponding to a particular webpage, a page key group entity type corresponding to a particular group of webpages, and a user action entity type corresponding to a particular user action.

In some embodiments, the user action corresponds to at least one of viewing content, selecting content, liking content, sharing content, commenting on content, following content, uploading an address book, transmitting a member-to-member invitation, accepting a member-to-member invitation, endorsing a member for a skill, and editing a member profile page. In some embodiments, the particular webpage corresponds to at least one of a home page, content feed page, a member profile page, a profile edit page, a job page, a company page, a group page, an educational institution page, an influencer page, and a people-you-may-know page. In some embodiments, the particular group of webpages corresponds to at least one of a profile page group, a job page group, a company page group, a group page group, an educational institution page group, an influencer page group, and a people-you-may-know page group.

In operation 1202 in FIG. 12, the presentation module 206 displays a user interface element (e.g., see Level One count bar 501 in FIG. 6) indicating an amount of total online user sessions (“2,133,456” in 501) that include user interactions with at least one of the entities in the first set (e.g., see 405 in FIG. 6) during the specific time interval (e.g., see 408 in FIG. 4). In some embodiments, the data structure processing module 204 may access a data structure storing a plurality of data structure entities (see data structure entities 1100 in FIG. 11), each of the data structure entities corresponding to an online user session on an online social networking service and describing one or more user interaction events included in the corresponding online user session. Thereafter, the data structure processing module 204 may retrieve, from the data structure, a set of the plurality of data structure entities (see data structure entities 1100-1 in FIG. 11) corresponding to online user sessions that include a user interaction event with at least one of the entities in the first set during the specific time interval. The data structure processing module 204 may then provide this information to the presentation module 206 for display to a user, via a user interface.

In operation 1203 in FIG. 12, the request module 202 receives a user specification of a second set of one or more entities (e.g., see 805 in FIG. 9). In operation 1204 in FIG. 12, the presentation module 206 displays a second user interface element (e.g., see Level Two count bar 801 in FIG. 9) indicating a subset of the total online user sessions that include user interactions with at least one of the entities in the second set (e.g., see 805 in FIG. 9) subsequent to the user interactions with at least one of the entities in the first set (e.g., see 405 in FIG. 6). For example, the data structure processing module 204 may retrieve a subset of the set of data structure entities (e.g., see data structure entities 1100-2 in FIG. 11) corresponding to online user sessions that include user interaction events with at least one of the entities in the second set subsequent to the user interaction events with at least one of the entities in the first set. The data structure processing module 204 may then provide this information to the presentation module 206 for display to a user, via a user interface.

In some embodiments, the first and second user interface elements correspond to graphical user interface elements (e.g., see Level One count bar 501 and Level Two count bar 801 in FIG. 9). For example, in some embodiments, the first and second user interface elements correspond to bar graphs.

In some embodiments, the second user interface element (e.g., Level Two count bar 801 in FIG. 9) includes a first portion, a second portion, and a third portion with distinct colors or shading (e.g., see 801a, 801b, and 801c in FIG. 9). The first, second, or third portions represent user sessions in the subset of the total online user sessions (as represented by entire Level Two count bar 801 in FIG. 9) that include user interaction with entities in the second set associated with the page key entity type, or the page key group entity type, or the user action entity type, respectively. In other words, each entity type is associated with a different color or shading in the count bars. In order to generate such colored portions, the data structure processing module 204 may calculate a first amount, a second amount, and a third amount of the subset of data structure entities (e.g., see data structure entities 1100-2 in FIG. 11) that include user interaction events with entities in the second set associated with the page key entity type, the page key group entity type, and the user action entity type, respectively. The data structure processing module 204 may then provide this information to the presentation module 206 for display to a user, via a user interface.

In some embodiments, the second user interface element (e.g., Level Two count bar 801 in FIG. 9) indicates a percentage (e.g., 45.7% in FIG. 9) of the total online user sessions that include user interactions with at least one of the entities in the second set (e.g., see 805 in FIG. 9) subsequent to the user interaction with at least one of the entities in the first set (e.g., see 405 in FIG. 6). In order to generate such as a percentage, the data structure processing module 204 may calculate a percentage of the set of data structure entities (e.g., see data structure entities 1100-1 in FIG. 11) that corresponds to the subset of the set of data structure entities (e.g., see data structure entities 1100-2 in FIG. 11). Thereafter, the data structure processing module 204 may provide the percentage to the user, via the user interface.

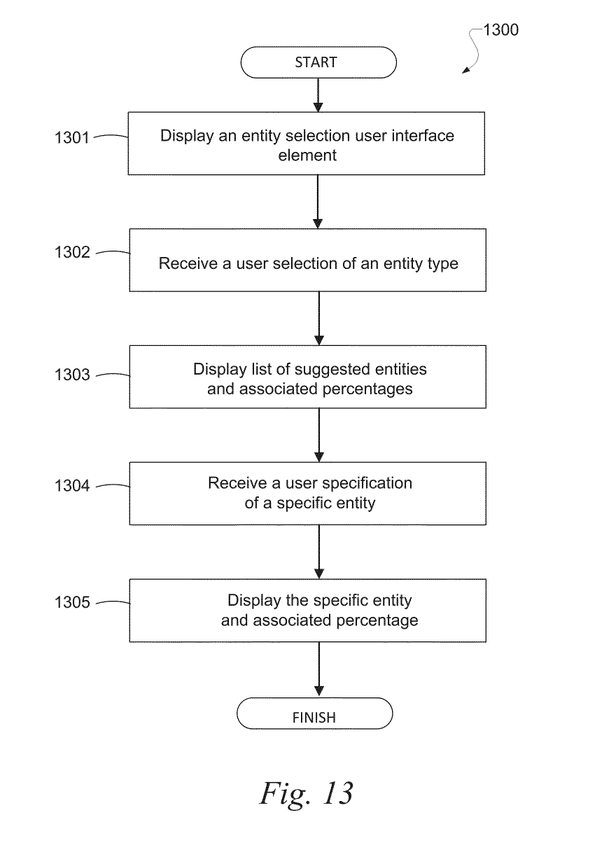

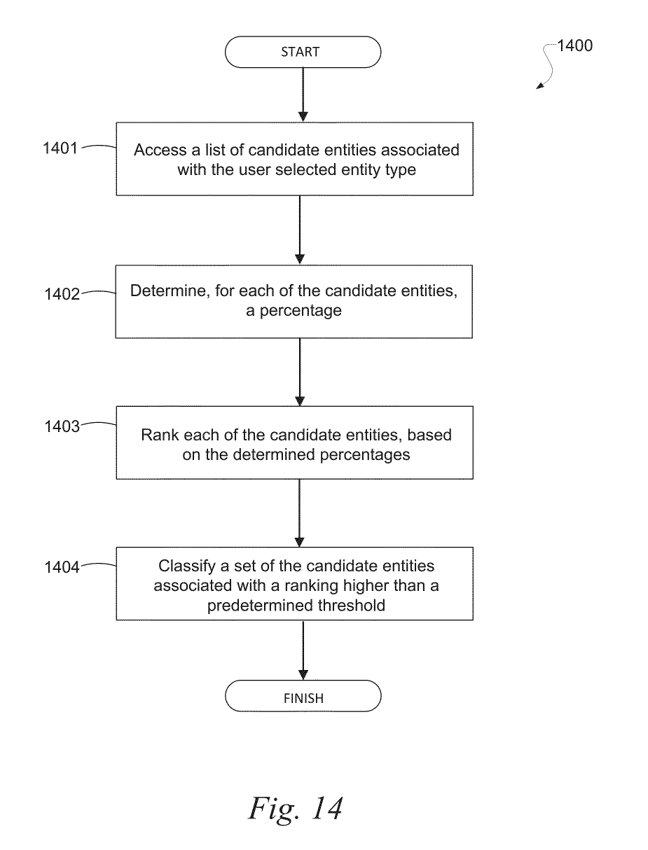

FIG. 13 is a flowchart illustrating an example method 1300 for receiving a user specification of a set of one more entities, consistent with various embodiments described above. In some embodiments, the method 1300 may correspond to, for example, operation 1201 and/or operation 1203 in FIG. 12. The method 1300 may be performed at least in part by, for example, the funnel analysis system 200 illustrated in FIG. 2 (or an apparatus having similar modules, such as one or more client machines or application servers). In operation 1301, the presentation module 206 displays an entity selection user interface element including a page key entity type selector, a page key group entity type selector, and a user action entity type selector (e.g., see 702-704 in FIG. 7). In operation 1302, the request module 202 receives a user selection of an entity type, based on a user selection of one of the page key entity type selector, the page key group entity type selector, and the user action entity type selector (e.g., see 702-704 in FIG. 7). In operation 1303, the presentation module 206 optionally displays a list of one or more suggested entities associated with the user selected entity type (e.g., see 707a and 707b in FIG. 7). For example, the data structure processing module 204 may generate a list of one or more suggested entities associated with the user selected entity type, and provide the list to the presentation module 206 for display to a user (e.g., see 707a and 707b in FIG. 7). The presentation module 206 may also display, in conjunction with each of the suggested entities, a percentage (e.g., see 707a and 707b in FIG. 7). The percentage may indicate the percentage of the total online user sessions (e.g., as represented by the Level One count bar 501) that include user interactions with the corresponding suggested entity subsequent to the user interactions with at least one of the entities in a first set (e.g., indicated in the Level One count bar 501). The generation of the list of suggested entities and associated percentages is described in greater detail below in conjunction with FIG. 14.

In operation 1304, the request module 202 receives a user specification of a specific entity (e.g., see entity specification bar 805 in FIG. 8) associated with the entity type selected by the user in operation 1302 (e.g., see 702-704 in FIG. 7). For example, the request module 202 may receive a user specification of one of the suggested entities displayed in operation 1303 as the specific entity. In operation 1305, the presentation module 206 displays the specific entity (e.g., see entity specification bar 805 in FIG. 8) and percentages associated with each entity. The percentages indicate the percentage of the total online user sessions (e.g., as represented by the Level One count bar 501) that include user interactions with the selected entity subsequent to the user interactions with at least one of the entities in the first set (e.g., indicated in the Level One count bar 501). For example, the data structure processing module 204 may generate a percentage of the set of data structure entities (e.g., see data structure entities 1100-1 in FIG. 11) that include user interaction events with the specific entity selected by the user (e.g., see entity specification bar 805 in FIG. 8) subsequent to the user interaction events with at least one of the entities in the first set (e.g., indicated in the Level One count bar 501), and the presentation module 206 may display the generated percentage. It is contemplated that the operations of method 1300 may incorporate any of the other features disclosed herein. Various operations in the method 1300 may be omitted or rearranged, as necessary.

FIG. 14 is a flowchart illustrating an example method 1400 for identifying a list of suggested entities (such as the suggested entities described in operation 1303 in FIG. 13), consistent with various embodiments described above. The method 1400 may be performed at least in part by, for example, the funnel analysis system 200 illustrated in FIG. 2 (or an apparatus having similar modules, such as one or more client machines or application servers). In operation 1401, the data structure processing module 204 accesses a list of candidate entities associated with a user selected entity type (e.g., see 702-704 in FIG. 7). In operation 1402, the data structure processing module 204 determines, for each of the candidate entities, a percentage of the total online user sessions (e.g., as represented by the Level One count bar 501) that include user interactions with the corresponding candidate entity subsequent to the user interactions with at least one of the entities in a first set (e.g., indicated in the Level One count bar 501). For example, the data structure processing module 204 may determine, for each of the candidate entities, a percentage of the set of data structure entities (e.g., see data structure entities 1100-1 in FIG. 11) that include user interaction events with the corresponding candidate entity subsequent to the user interaction events with at least one of the entities in the first set (e.g., indicated in the Level One count bar 501). In operation 1403, the data structure processing module 204 ranks each of the candidate entities, based on the percentages determined in operation 1402. In operation 1404, the data structure processing module 204 classifies, as the suggested entities, a set of the candidate entities associated with a ranking higher than a predetermined threshold (e.g., the top 5 or the bottom 5, as illustrated in FIG. 8). It is contemplated that the operations of method 1400 may incorporate any of the other features disclosed herein. Various operations in the method 1400 may be omitted or rearranged, as necessary.

In some embodiments, when a particular suggested entity is selected (e.g., if the operator selects the “Invitation-accept” 810 suggested entity in FIG. 8, and thus associates it with Level Two, as seen in the entity specification 805 in FIG. 9), then the corresponding suggested entities may be updated accordingly, as seen in FIGS. 8 and 9 (e.g., where the “Endorse” suggested entity that was next highly ranked takes the place of the “Invitation-accept” suggested entity, and the new “Follow-influencer” suggested entity takes the place of the “Endorse” suggested entity). For example, the data structure processing module 204 may repeat the method 1400 by removing the user-selected entity from the list of candidate entities between operations 1401 and 1402.

According to various example embodiments, the data structure processing module 204 may perform a de-duplication process with respect to the counts included in the various count bars. For example, suppose a particular page key group y includes a particular page key y1, and there are 10,000 sessions with interactions with page key group y that include 2,000 sessions with interactions with page key y1. If the operator happens to associate both the page key group y and the particular page key y1 with a given level, summing the total number of sessions associated with interactions with the page key group y (10,000) and the number of sessions associated with interactions with the page key yl (2,000) will lead to a total figure of 12,000 that double-counts the sessions with interactions with the page key y1 (since page key group y already includes the 2,000 sessions associated with interactions with the page key y1). Thus, the data structure processing module 204 may ensure that, if the user selects both page key group y and page key y1 that is already included in page key group y, the additional session counts associated with only the additionally added page key y1 element will be disregarded.

In some embodiments, the entities described in Level One need not be the first interaction event in a session, but may simply be any interaction event in a session, with Level Two defining the subsequent interaction event. For example, with reference in the data chains 1100 in FIG. 11, if the operator associates Pv1 with Level One, then the data structure processing module 204 may retrieve not just sessions S1-S3 where Pv1 is the first interaction event, but also session S4 where Pv1 is the third interaction event. Moreover, if the operator associates Pv2 with Level Two, then the data structure processing module 204 will retrieve session S1, S2, and S4, since Pv2 is immediately subsequent to Pv1 in each of these sessions.

According to various example embodiments, the funnel analysis system 200 also enables operators to view not only how users are funneling to various entities, but also how users are funneling from various entities. For example, if the operator selects the “From” button 1004 in FIG. 10 to engage a reverse funnel mode, the funnel analysis system 200 calculates how many sessions include interactions with the entities defined at the Level One, and how many of those sessions included interactions with the entities defined at the Level Two prior to the interactions with the entities defined at the Level One, and how many of those sessions included interactions with the entities defined at the Level Three prior to the interactions with the entities defined at the Level Two, and so on. For example, with reference in the data chains 1100 in FIG. 11, if the operator associates Pv1 with Level One, then the data structure processing module 204 may retrieve sessions S1-S4 where Pv1 is an interaction event. Moreover, if the operator associates Pv3 with Level Two, then the data structure processing module 204 will retrieve session S4, since Pv3 is immediately prior to Pv1 in session S4.

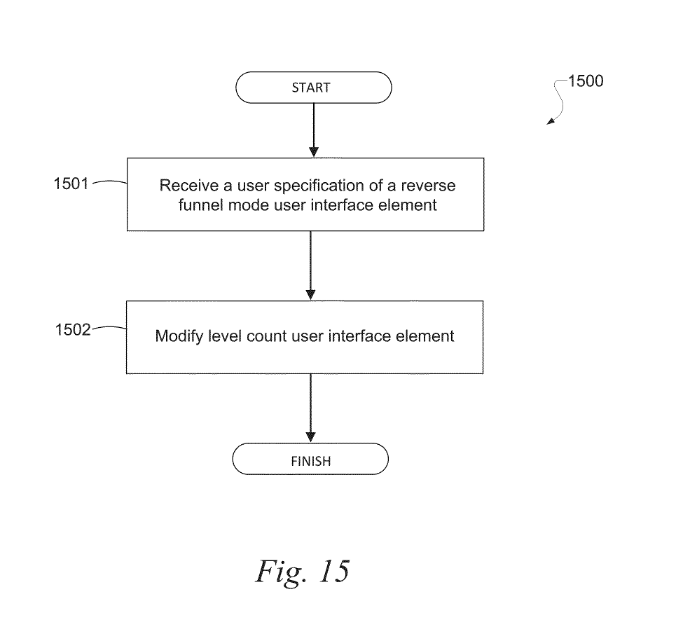

FIG. 15 is a flowchart illustrating an example method 1500, consistent with various embodiments described above. The method 1500 may be performed at least in part by, for example, the funnel analysis system 200 illustrated in FIG. 2 (or an apparatus having similar modules, such as one or more client machines or application servers). In operation 1501, the request module 202 receives a user specification of a reverse funnel mode user interface element (e.g., see 1004 in FIG. 10). In operation 1502, the presentation module 206 modifies a level count user interface element (e.g., see 801 in FIG. 10) to indicate an amount of the total online user sessions (e.g., as represented by Level One count bar 501) that include user interactions with at least one of the entities in a second set (e.g., as indicated in Level Two count bar 801) prior to the user interaction with at least one of the entities in a first set (e.g., as indicated in Level One count bar 501). For example, the data structure processing module 204 may retrieve a subset of set of data structure entities corresponding to online user sessions that include user interaction events with at least one of the entities in a second set (e.g., as indicated in Level Two count bar 801) prior to the user interaction events with at least one of the entities in the first set (e.g., as indicated in Level One count bar 501). Thereafter, the data structure processing module 204 may provide information regarding the subset of data structure entities to the user, via the user interface. It is contemplated that the operations of method 1500 may incorporate any of the other features disclosed herein. Various operations in the method 1500 may be omitted or rearranged, as necessary.

### Example Mobile Device

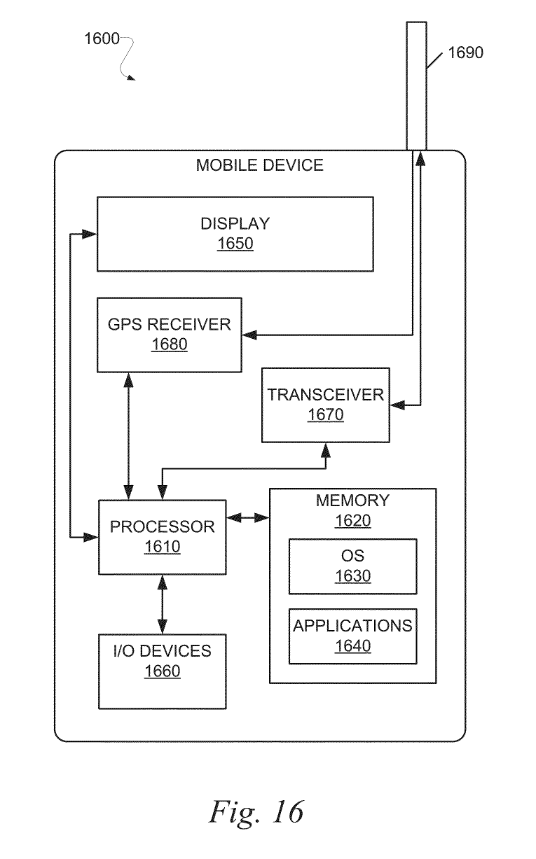

FIG. 16 is a block diagram illustrating the mobile device 1600, according to an example embodiment. The mobile device may correspond to, for example, one or more client machines or application servers. One or more of the modules of the system 200 illustrated in FIG. 2 may be implemented on or executed by the mobile device 1600. The mobile device 1600 may include a processor 1610. The processor 1610 may be any of a variety of different types of commercially available processors suitable for mobile devices (for example, an XScale architecture microprocessor, a Microprocessor without Interlocked Pipeline Stages (MIPS) architecture processor, or another type of processor). A memory 1620, such as a Random Access Memory (RAM), a Flash memory, or other type of memory, is typically accessible to the processor 1610. The memory 1620 may be adapted to store an operating system (OS) 1630, as well as application programs 1640, such as a mobile location enabled application that may provide location based services to a user. The processor 1610 may be coupled, either directly or via appropriate intermediary hardware, to a display 1650 and to one or more input/output (I/O) devices 1660, such as a keypad, a touch panel sensor, a microphone, and the like. Similarly, in some embodiments, the processor 1610 may be coupled to a transceiver 1670 that interfaces with an antenna 1690. The transceiver 1670 may be configured to both transmit and receive cellular network signals, wireless data signals, or other types of signals via the antenna 1690, depending on the nature of the mobile device 1600. Further, in some configurations, a GPS receiver 1680 may also make use of the antenna 1690 to receive GPS signals.

### Modules, Components And Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

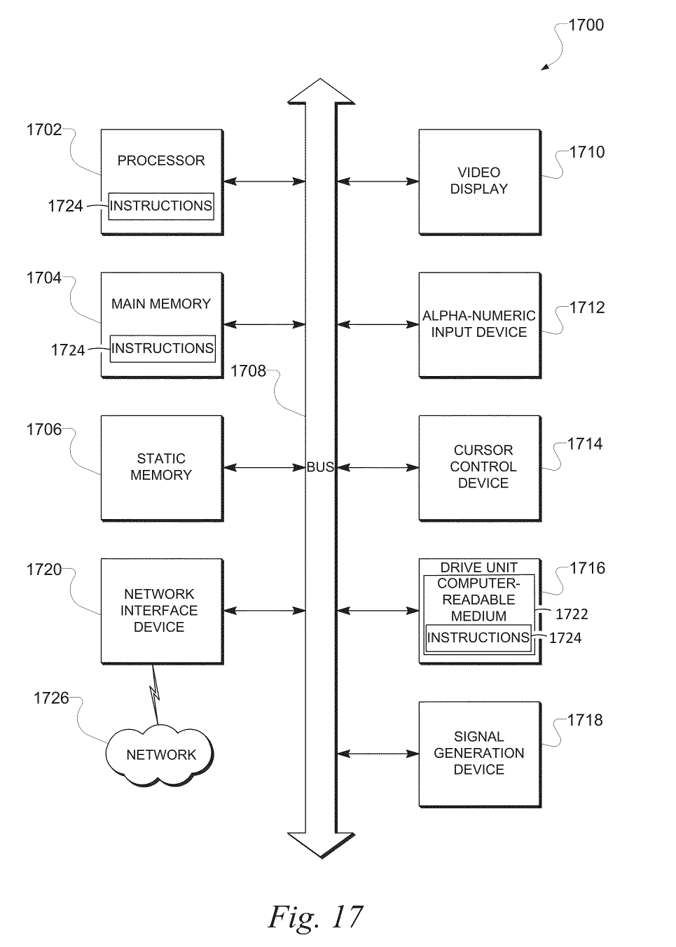

FIG. 17 is a block diagram of machine in the example form of a computer system 1700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1700 includes a processor 1702 (e.g., a central processing unit (CPU), a graphics processing unit (GPU) or both), a main memory 1704 and a static memory 1706, which communicate with each other via a bus 1708. The computer system 1700 may further include a video display unit 1710 (e.g., a liquid crystal display (LCD) or a cathode ray tube (CRT)). The computer system 1700 also includes an alphanumeric input device 1712 (e.g., a keyboard or a touch-sensitive display screen), a user interface (UI) navigation device 1714 (e.g., a mouse), a disk drive unit 1716, a signal generation device 1718 (e.g., a speaker) and a network interface device 1720.

### Machine-Readable Medium

The disk drive unit 1716 includes a machine-readable medium 1722 on which is stored one or more sets of instructions and data structures (e.g., software) 1724 embodying or utilized by any one or more of the methodologies or functions described herein. The instructions 1724 may also reside, completely or at least partially, within the main memory 1704 and/or within the processor 1702 during execution thereof by the computer system 1700, the main memory 1704 and the processor 1702 also constituting machine-readable media.

While the machine-readable medium 1722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1724 may further be transmitted or received over a communications network 1726 using a transmission medium. The instructions 1724 may be transmitted using the network interface device 1720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving a user specification of a first set of one or more entities and a specific time interval, each of the entities in the first set being associated with at least one of a page key entity type corresponding to a particular webpage, a page key group entity type corresponding to a particular group of webpages, and a user action entity type corresponding to a particular user action;
displaying a user interface element indicating an amount of total online user sessions that include user interactions with at least one of the entities in the first set during the specific time interval;
receiving a user specification of a second set of one or more entities, each of the entities in the second set being associated with at least one of a page key entity type corresponding to a particular webpage, a page key group entity type corresponding to a particular group of webpages, and a user action entity type corresponding to a particular user action; and
displaying, using one or more processors, a second user interface element indicating a subset of the total online user sessions that include user interactions with at least one of the entities in the second set subsequent to the user interactions with at least one of the entities in the first set.

2. The method of claim 1, wherein the first and second user interface elements correspond to graphical user interface elements.

3. The method of claim 1, wherein the first and second user interface elements correspond to bar graphs.

4. The method of claim 1, wherein the second user interface element includes a first portion, a second portion, and a third portion representing user sessions in the subset of the total online user sessions that include user interaction with entities in the second set associated with the page key entity type, the page key group entity type, and the user action entity type, respectively.

5. The method of claim 4, wherein the first portion, the second portion, and of the third portion have distinct colors or shading.

6. The method of claim 1, wherein the second user interface element indicates a percentage of the total online user sessions that include user interactions with at least one of the entities in the second set subsequent to the user interactions with at least one of the entities in the first set.

7. The method of claim 1, wherein the receiving of the user specification of the second set of one or more entities further comprises:
displaying an entity selection user interface element including a page key entity type selector, a page key group entity type selector, and a user action entity type selector;
receiving a user selection of an entity type, based on a user selection of one of the page key entity type selector, the page key group entity type selector, and the user action entity type selector; and
receiving a user specification of a specific entity in the second set associated with the user selected entity type.

8. The method of claim 7, further comprising:
responsive to receiving the user selection of the entity type, displaying a list of one or more suggested entities associated with the user selected entity type; and
receiving the user specification of the specific entity in the second set, based on a user selection of one of the suggested entities.

9. The method of claim 8, further comprising:
displaying, in conjunction with each of the suggested entities, a percentage of the total online user sessions that include user interactions with the corresponding suggested entity subsequent to the user interactions with at least one of the entities in the first set.

10. The method of claim 7, further comprising:
responsive to receiving the user specification of the specific entity in the second set, displaying a percentage of the total online user sessions that include user interactions with the specific entity in the second set subsequent to the user interactions with at least one of the entities in the first set.

11. The method of claim 1, further comprising:
receiving a user specification of a reverse funnel mode user interface element; and
modifying the second user interface element to indicate an amount of the total online user sessions that include user interactions with at least one of the entities in the second set prior to the user interaction with at least one of the entities in the first set

12. The method of claim 1, wherein the user action corresponds to at least one of viewing content, selecting content, liking content, sharing content, commenting on content, following content, uploading an address book, transmitting a member-to-member invitation, accepting a member-to-member invitation, endorsing a member for a skill, and editing a member profile page.

13. The method of claim 1, wherein the particular webpage corresponds to at least one of a home page, content feed page, a member profile page, a profile edit page, a job page, a company page, a group page, an educational institution page, an influencer page, and a people-you-may-know page.

14. A system comprising:
a request module, implemented by one or more processors, configured to a user specification of a first set of one or more entities and a specific time interval, each of the entities in the first set being associated with at least one of a page key entity type corresponding to a particular webpage, a page key group entity type corresponding to a particular group of webpages, and a user action entity type corresponding to a particular user action;
a presentation module, implemented by one or more processors, configured to a user interface element indicating an amount of total online user sessions that include user interactions with at least one of the entities in the first set during the specific time interval,
the request module being further configured to receive a user specification of a second set of one or more entities, each of the entities in the second set being associated with at least one of a page key entity type corresponding to a particular webpage, a page key group entity type corresponding to a particular group of webpages, and a user action entity type corresponding to a particular user action, and
the presentation module being further configured to display a second user interface element indicating a subset of the total online user sessions that include user interactions with at least one of the entities in the second set subsequent to the user interactions with at least one of the entities in the first set.

15. The system of claim 14, wherein the second user interface element includes a first portion, a second portion, and a third portion representing user sessions in the subset of the total online user sessions that include user interaction with entities in the second set associated with the page key entity type, the page key group entity type, and the user action entity type, respectively.

16. The system of claim 14, wherein the second user interface element indicates a percentage of the total online user sessions that include user interactions with at least one of the entities in the second set subsequent to the user interactions with at least one of the entities in the first set.

17. The system of claim 14, wherein the receiving of the user specification of the second set of one or more entities further comprises:
displaying an entity selection user interface element including a page key entity type selector, a page key group entity type selector, and a user action entity type selector;
receiving a user selection of an entity type, based on a user selection of one of the page key entity type selector, the page key group entity type selector, and the user action entity type selector; and
receiving a user specification of a specific entity in the second set associated with the user selected entity type.

18. A non-transitory machine-readable storage medium comprising instructions that, when executed by one or more processors of a machine, cause the machine to perform operations comprising:
receiving a user specification of a first set of one or more entities and a specific time interval, each of the entities in the first set being associated with at least one of a page key entity type corresponding to a particular webpage, a page key group entity type corresponding to a particular group of webpages, and a user action entity type corresponding to a particular user action;
displaying a user interface element indicating an amount of total online user sessions that include user interactions with at least one of the entities in the first set during the specific time interval;
receiving a user specification of a second set of one or more entities, each of the entities in the second set being associated with at least one of a page key entity type corresponding to a particular webpage, a page key group entity type corresponding to a particular group of webpages, and a user action entity type corresponding to a particular user action; and
displaying a second user interface element indicating a subset of the total online user sessions that include user interactions with at least one of the entities in the second set subsequent to the user interactions with at least one of the entities in the first set.

19. The storage medium of claim 18, wherein the second user interface element includes a first portion, a second portion, and a third portion representing user sessions in the subset of the total online user sessions that include user interaction with entities in the second set associated with the page key entity type, the page key group entity type, and the user action entity type, respectively.

20. The storage medium of claim 18, wherein the receiving of the user specification of the second set of one or more entities further comprises:
displaying an entity selection user interface element including a page key entity type selector, a page key group entity type selector, and a user action entity type selector;
receiving a user selection of an entity type, based on a user selection of one of the page key entity type selector, the page key group entity type selector, and the user action entity type selector; and
receiving a user specification of a specific entity in the second set associated with the user selected entity type.
